(19) United States
(12) Patent Application Publication
(10) Pub. No.: US 2002/0062094 A1
(43) Pub. Date: May 23, 2002

(54) Medical module apparatus

(76) Inventors: Masao Kasuga, Chiba-shi (JP); Takashi Yamanaka, Chiba-shi (JP); Akihiro Iino, Chiba-shi (JP)

Correspondence Address: ADAMS & WILKS, 31st FLOOR, 50 BROADWAY, NEW YORK, NY, 10004, US

(21) Appl. No.: 09/956,308

(22) Filed: Sep. 19, 2001

(30) Foreign Application Priority Data
Sep. 22, 2000 (JP) 2000-288299

(51) Int. Cl. A61H 1/00

(52) U.S. Cl. 601/2

(57) ABSTRACT

To provide a medical module apparatus for moving a moving body such as an ultrasonic vibrator with excellent characteristics of the response and making a sectional area in an inserting direction of the moving member smaller than that of a conventional product, the medical module apparatus includes a piezoelectric vibrator substantially in a rectangular shape for producing ultrasonic vibration, a rotating body rotated with ultrasonic vibration produced at an end portion of the piezoelectric vibrator as power, a guide wire for supporting the piezoelectric vibrator and the rotating body such that an end portion of the piezoelectric vibrator is directed in a direction of inserting the medical module apparatus and moving the medical module apparatus to an aimed portion and a skin for protecting the piezoelectric vibrator and the rotating body against outside.

### BACKGROUND OF THE INVENTION

1. Field of the Invention

The present invention relates to a medical module apparatus capable of being inserted into a deep portion in the body such as a deep portion of the vessel and provided with a degree of freedom in movement of essential portions at a distal end thereof by including a power source.

2. Description of the Related Art

In recent years, by progress of micro-machine technology, it is expected to apply a micro-machine in medical apparatus. Particularly, there has been progressed a development of treatment apparatus or inspection apparatus for realizing low invasive treatment by functioning at a narrow portion in the body such as in the various organs or in the vessel in order to alleviate burden on patients.

As a representative example, there is provided an ultrasonic endoscope attached to a catheter, inserted into the stomach, the ureter, the vessel or the like, emitting ultrasonic beam from an ultrasonic vibrator attached to a distal end thereof and catching a reflected wave thereof. In order to provide a tomographic image by the ultrasonic endoscope, it is necessary to mechanically rotate or change the ultrasonic vibrator.

However, according to an ultrasonic endoscope which has been reduced into practice, there is adopted a system of transmitting rotational force of an external motor to an ultrasonic vibrator at a distal end thereof by a wire in a catheter. That is, a wire having high rigidity to a degree of capable of transmitting the rotational force passes through a catheter and therefore, rigidity of a catheter main body is increased and it has been difficult to insert the ultrasonic vibrator up to a deep portion of the human body.

Further, when a catheter is bent in accordance with the vessel, the radius of curvature may be reduced. In that case, the wire is brought into contact with a tube inner wall of the catheter to thereby produce friction, the rotational force cannot be transmitted smoothly to the ultrasonic vibrator and nonuniformity of rotation may be caused in the ultrasonic vibrator to thereby cause a disturbance in an image.

Further, although it is also conceivable to adopt a system of including an electromagnetic type actuator at the distal end and a system of using a shape memory alloy, in the former case, the electromagnetic type actuator may erroneously be operated when a strong magnetic field is applied thereon as in an MRI apparatus and in the latter case, the characteristics of the response are poor.

Further, Japanese Patent Laid-open No. 124103/1995 and Japanese Patent Laid-open No 173434/1996 disclose a mechanism of moving an ultrasonic vibrator by connecting the ultrasonic vibrator to a bimorph type piezoelectric element. However, according to the mechanism, there can be realized only a pivotally moving mechanism pivotally moving only in a limited range and rotational movement cannot be carried out.

It is a problem of the invention to provide a medical module apparatus capable of moving a moving body such as an ultrasonic vibrator with excellent characteristics of the response without using a wire having high rigidity and making a sectional area thereof in an inserting direction smaller than that in the conventional apparatus. Further, it is also an object of the invention to provide a medical module apparatus making a pivotally moving range of a moving body wider than that in the conventional apparatus and capable of carrying out rotational movement of the moving body.

### SUMMARY OF THE INVENTION

In order to resolve the above-described problem, according to an aspect of the invention, there is provided a medical module apparatus which is a medical module apparatus inserted into the body, the medical module apparatus comprising a piezoelectric vibrator substantially in a rectangular shape for producing ultrasonic vibration, a moving member moved with the ultrasonic vibration produced at an end portion of the piezoelectric vibrator as a power, a guide wire for supporting the piezoelectric vibrator and the moving member in a state in which the end portion of the piezoelectric vibrator is directed in a direction of inserting the medical module apparatus and moving the medical module apparatus to an aimed portion, a skin for protecting the piezoelectric vibrator and the moving member against an outside portion, and a drive circuit and a control circuit for controlling to drive the piezoelectric vibrator.

According to the invention, there is constructed a constitution in which an output member is provided at the end portion of the piezoelectric vibrator in a plate-like shape and the moving member is moved by the power transmitted from the output member and therefore, the moving member can be moved with excellent characteristics of the response without using a wire having high rigidity. Further, the moving direction and range can be made wider than those in the conventional product.

Further, there is constructed a constitution in which the end portion of the piezoelectric vibrator is directed in the direction of inserting the medical module apparatus and the end portion is connected in series with the output member and the moving member and therefore, a sectional area of a space necessary for installing these is reduced and can be reduced to a degree equal to, for example, a sectional area of the guide wire. Further, the moving member is moved with ultrasonic vibration produced at the end portion of the piezoelectric vibrator as a power source and therefore, a width of the piezoelectric vibrator in the inserting direction can simply be reduced (for example, larger than 0 mm and equal to or smaller than 2 mm). That is, the medical module apparatus can be made smaller than the conventional product and can be inserted into the deep portion in the body such as a deep portion of the vessel.

Here, as the moving member, there is exemplified an ultrasonic vibrator of an ultrasonic endoscope, an inspection and treatment member such as a removing member for resolving a closed situation by removing a closed object in a closed portion of the vessel, or a guiding member projected from a distal end portion of the medical module apparatus with an angle therebetween for guiding the medical module apparatus in a desired direction by preceding the front end portion.

Further, as an example of the piezoelectric vibrator, there is constructed a constitution having a first piezoelectric layer producing vertical vibration and a second piezoelectric layer producing bending vibration. In this way, the ultrasonic vibration of the end portion is elliptic vibration provided by synthesizing the vibrations produced in the first and the second piezoelectric layers.

Further, when a self-excited oscillation circuit is used as the drive circuit, driving operation in a stable state can be realized without constituting a complicated circuit.

Further, the moving member is rotated or pivotally moved by the piezoelectric vibrator.

As a specific constitution of the former, there is constructed a constitution in which the moving member is rotatably penetrated by a shaft provided in the inserting direction and the end portion of the piezoelectric vibrator is brought into contact with the moving member such that drive force is directed in the rotational direction of the moving body. In this case, a rotatable range of the moving member is not limited.

As a specific constitution of the latter, there is constructed a constitution in which the moving member is pivotably penetrated by a shaft provided in a direction of a section of the medical nodule apparatus and the end of the piezoelectric vibrator is brought into contact with the moving member such that drive force is directed in a direction of pivotally moving the moving member.

### BRIEF DESCRIPTION OF THE DRAWINGS

FIG. 1 is a block diagram showing a constitution of a medical module apparatus according to a first embodiment of the invention;

FIGS. 2A and 2B are outline views showing the constitution of the medical module apparatus of FIG. 1 in which FIG. 2A is a vertical sectional view and FIG. 2B is a vertical sectional view rotating the apparatus by 90 degree from that in FIG. 2A;

FIGS. 3A, 3B, 3C, 3D, 3E and 3F are plane views of piezoelectric sheets constituting a piezoelectric vibrating element of FIG. 1;

FIG. 4 is a block diagram for explaining a constitution of a drive control circuit of FIG. 1;

FIGS. 5A and 5B are outline views showing a constitution of a medical module apparatus according to a second embodiment of the invention in which FIG. 5A is a vertical sectional view and FIG. 5B is a vertical sectional view rotating the apparatus by 90 degree from that in FIG. 5A;

FIGS. 6A and 6B are outline views showing a constitution of a medical module apparatus according to a third embodiment of the invention in which FIG. 6A is a vertical sectional view and FIG. 6B is a vertical sectional view rotating the apparatus by 90 degree from that in FIG. 6A; and

FIGS. 7A and 7B are outline views showing a constitution of a medical module apparatus according to a fourth embodiment of the invention in which FIG. 7A is a vertical sectional view and FIG. 7B is a vertical sectional view rotating the apparatus by 90 degree from that in FIG. 7A.

### DESCRIPTION OF THE PREFERRED EMBODIMENTS

First Embodiment

First, an explanation will be given of the constitution.

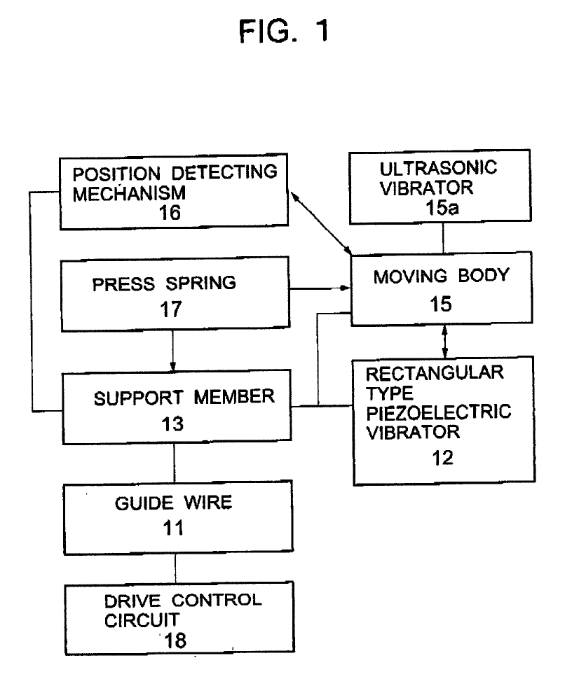

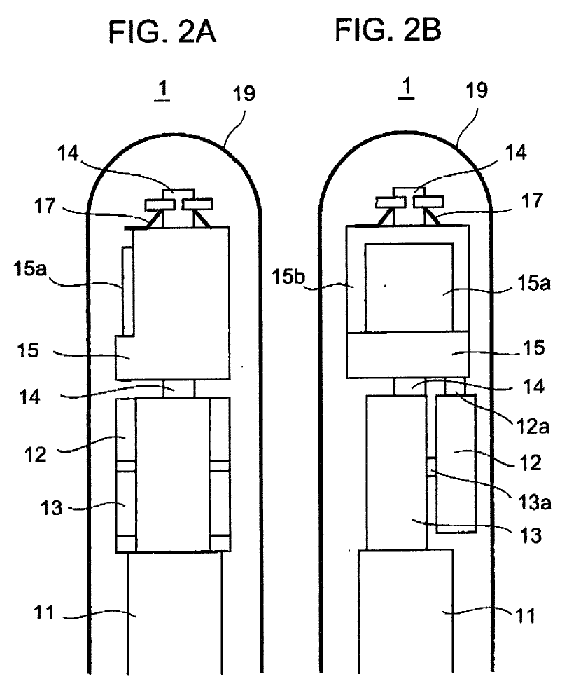

A medical module apparatus I constituting a first embodiment of the invention is an ultrasonic endoscope and as shown by FIG. 1 and FIGS. 2A and 2B, the medical module apparatus 1 is constructed by a constitution in which a rectangular piezoelectric vibrator 12 is attached to a distal end of a well known guide wire 11 via a support member 13, a shaft 14 is projected and fixed to a front end of the support member 13, a rotating body 15 holding an ultrasonic vibrator 15a is attached to the shaft 14 rotatably and such that the rotating member 15 is brought into contact with an output projection 12a of the piezoelectric vibrator 12, a position detecting mechanism 16 (not illustrated in FIG. 2) for detecting a rotational mount and accordingly, a position of the rotating body 15, is attached to the support member 13, a press spring 17 for bringing the rotating body 15 into press contact with the output projection 12a is attached to a front end of the shaft 14, the piezoelectric vibrator 12 and the position detecting mechanism 16 are connected to a drive control circuit 18 (not illustrated in FIG. 2) at outside of the body via the guide wire 11 and a portion of the endoscope inserted into the body is covered by a well-known skin 19.

Here, the ultrasonic vibrator 15a is a well-known element used in the ultrasonic endoscope.

The piezoelectric vibrator 12 is formed in the rectangular shape and is constructed by a structure in which piezoelectric sheets 121 through 126 are laminated in this order and the output projection 12a is provided at an end face thereof and is fixed such that drive force is directed in a circumferential direction of a section of the medical module apparatus 1.

As shown by Pig. 3A, the piezoelectric sheet 121 is constructed by the constitution in which divided portions thereof formed by equally dividing an upper face thereof in twos in the vertical direction and the horizontal direction, are polarized alternately in the up and down direction, electrodes 121a are provided at upper faces of the polarized portions polarized in one direction and electrodes 121b are provided on upper faces of the polarized portions polarized in other direction, respectively.

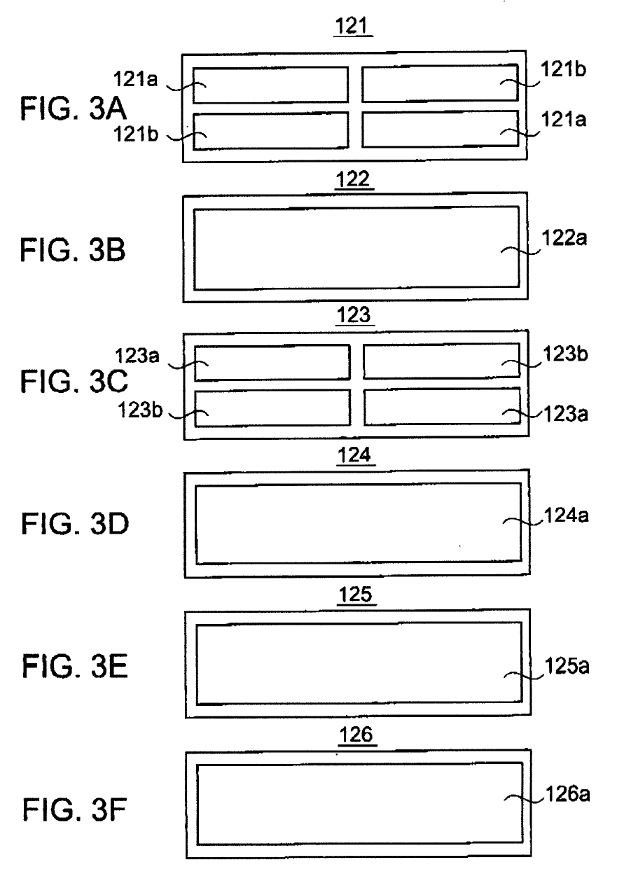

As shown by FIG. 3B, the piezoelectric sheet 122 is constructed by a constitution in which a total thereof is polarized in the up and down direction as one polarized portion and an electrode 122a is provided at an upper face of the polarized portion.

As shown by FIG. 3C, the piezoelectric sheet 123 is constructed by a polarized constitution and an electrode constitution similar to those in the piezoelectric sheet 121 and is provided with twos of electrodes 123a and 123b respectively on upper faces of the polarized portions.

AS shown by FIGS. 3D, 3E and 3F, the piezoelectric sheets 124, 125 and 126 are constructed by a polarized constitution and an electrode constitution similar to those of the piezoelectric sheet 122 and provided with electrodes 122a on substantially entire upper faces.

Although the piezoelectric vibrator 12 having such a structure is driven by inputting the same drive signal to the piezoelectric sheets 121 through 126, the drive signal is inputted to only either of the electrodes 121a and 121b, similarly, the drive signal is inputted to only either of the electrodes 123a and 123b.

Here, bending vibration is mainly generated in the piezoelectric sheets 121, 122 and 123 and vertical vibration is mainly generated in the piezoelectric sheets 124, 125 and 126. That is, the piezoelectric vibrator 12 generates elliptic vibration which is synthesized vibration of the bending vibration and the vertical vibration at an end face thereof and the elliptic vibration is amplified at the output projection 12a and is outputted to outside. Further, a rotational direction of the elliptic vibration becomes a positive direction by inputting the drive signal to the electrodes 121a and 123a and becomes a reverse direction by inputting the drive signal to the electrodes 121b and 123b. Further, when the rotational direction may be one direction, by pertinently changing electrode directions of the divided electrodes, the drive signal is inputted to all of the electrodes 121a, 121b, 123a and 123b to thereby enable to further increase the drive force.

The support member 13 is formed substantially in a rectangular shape and holds the piezoelectric vibrator 12 without influencing excitation thereof by fixing a center of a top face (or a center of a bottom face) of the piezoelectric vibrator 12 to a projection 13a provided at one face of the support member 13.

The rotating body 15 is formed substantially in a shape of a circular cylinder and provided with a through hole for passing the shaft 14 at a central portion thereof and the height is smaller than the length of the shaft 14. A portion of a side face the rotating body 15 is vertically scraped to constitute a plane portion 15b. The rotating body 15 holds the ultrasonic vibrator 15a at the plane portion 15b.

The rotational amount detecting means 16 is well-known optical rotational amount detecting means constituted by, for example, a light emitting element, a light receiving element and a slit rotating along with the rotating body 15 for outputting a detection result to the drive control circuit 18.

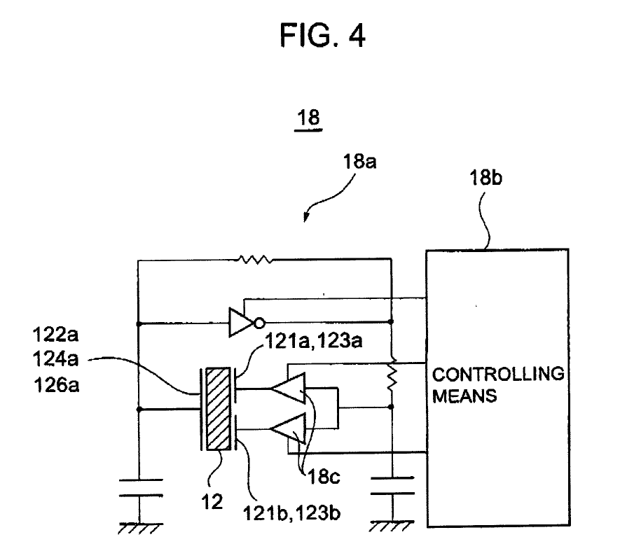

As exemplified in FIG. 4, the drive control circuit 18 is constituted by a self-excited oscillation circuit 18a and controlling means 18b which are well known. The controlling means 18b recognizes a direction of the ultrasonic vibrator 15a from the detection result of the rotational amount detecting means 16 and selects a combination of electrodes for inputting the drive signal, that is, the drive direction from the electrodes 121a and 123a and the electrodes 121b and 123b by controlling two buffers 18c of the self-excited oscillation circuit 18a.

Further, although not illustrated in FIG. 4, the drive control circuit 18 inputs the drive signal having a phase the same as that of the electrodes 121a and 123a or the electrodes 121b and 123b to the electrode 125.

According to the medical module apparatus 1 having the above-described constitution, when the piezoelectric oscillator 12 is driven in one direction, the drive force is transmitted to the rotating body 15 via the output projection 12a and rotates the rotating body 15a round the shaft 14 along with the ultrasonic vibrator 15a. Further, the rotating body 15a nd the ultrasonic vibrator 15a can be rotated in a reverse direction by reversing the direction of driving the piezoelectric vibrator 12. Therefore, even when the catheter is bent in accordance with the vessel and the radius of curvature is reduced, since the piezoelectric vibrator 12 at the distal end constitutes the power source, the direction of the ultrasonic vibrator 15a can be controlled with excellent characteristics of the response and excellent accuracy. Further,the rotational amount is not limited and any rotation can be carried out.

Further, since the medical module apparatus 1 is constructed by the constitution in which the rotating body 15 is rotated by using the output from the end face of the rectangular piezoelectric vibrator 12, the end face of the piezoelectric vibrator 12 can simply be downsized (for example a side thereof is downsized to be equal to or smaller than 2 mm). Further, since the end face of the piezoelectric vibrator 12 is provided in series with the rotating body 15a nd the ultrasonic vibrator 15a, a sectional area of a space necessary for installing these may be to a degree substantially equal to a sectional area of the guide wire 11

Therefore, according to the medical module apparatus 1, the sectional area in the inserting direction becomes smaller than that in the conventional product and the medical module apparatus 1 can be inserted into a deep portion in the body such as a deep portion of the vessel.

Second Embodiment

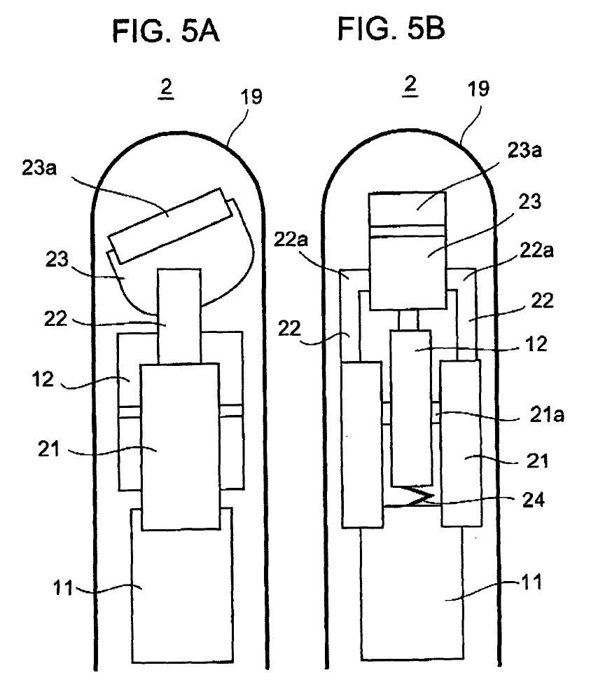

As shown by FIGS. 5A and 5B, a medical module apparatus 2 constituting an ultrasonic endoscope which is a second embodiment of the invention, is constructed by a constitution in which two of rectangular support members 21 are fixed to erect on the distal end face of the guide wire 11 such that projections 21a provided at side faces thereof are opposed to and separate from each other, the piezoelectric vibrator 12 is sandwiched and fixedly supported between the projections 21a, shafts 22 front end portions 22a of which are bent by 90 degree, are fixed to front end faces of the respective support members 21 such that the front end portions 22a are directed in directions the same as those of the projections 21a, a pivotally moving member 23 in a semispherical shape is pivotably integrated to between the front end portions 22a in a state in which a Hemispherical face thereof is brought into contact with the output projections 12a of the piezoelectric vibrator 12, an ultrasonic vibrator 23a is integrated to an upper plane of the pivotally moving member 23, a press spring 24 for pressing the piezoelectric vibrator 12 to the pivotally moving member 23 is provided between the piezoelectric vibrator 12 and the front end face of the guide wire 11, the drive control circuit 18 (not illustrated) at outside of the body is connected to the guide wire 11 and a portion of the medical module apparatus 2 inserted into the body is covered by a skin 19,

Here, the projections 21a support the piezoelectric vibrator 12 without influencing on excitation by fixing a center of a top face (or a center of a bottom face or a vicinity of a node of vibration) of the piezoelectric vibrator 12. As a result, the direction of the drive force of the piezoelectric vibrator 12 becomes orthogonal to the projections 21a and constitutes a direction of pivotally moving the pivotally moving member 23.

Therefore, according to the medical module apparatus 2, the ultrasonic vibrator 23a is pivotally moved by the piezoelectric vibrator 12 via the pivotally moving member 23. Therefore, the direction of the ultrasonic vibrator 23a can be controlled with excellent accuracy and excellent characteristics of the response. Further, a pivotally moving range of the pivotally moving member 23 is provided by about 270 degree which is wider than that of the conventional product.

Further, a diameter of a section of a space necessary for integrating the support member 21, the piezoelectric vibrator 12 and the shafts 22, becomes substantially equal to that of the section of the guide wire 11 and therefore, the sectional area in the direction of inserting the medical module apparatus 2 can be reduced.

Therefore, the sectional area of the medical module apparatus 2 in the inserting direction become smaller than that of the conventional product and the medical module apparatus 2 can be inserted up to a deep portion in the body such as a deep portion of the vessel.

Third Embodiment

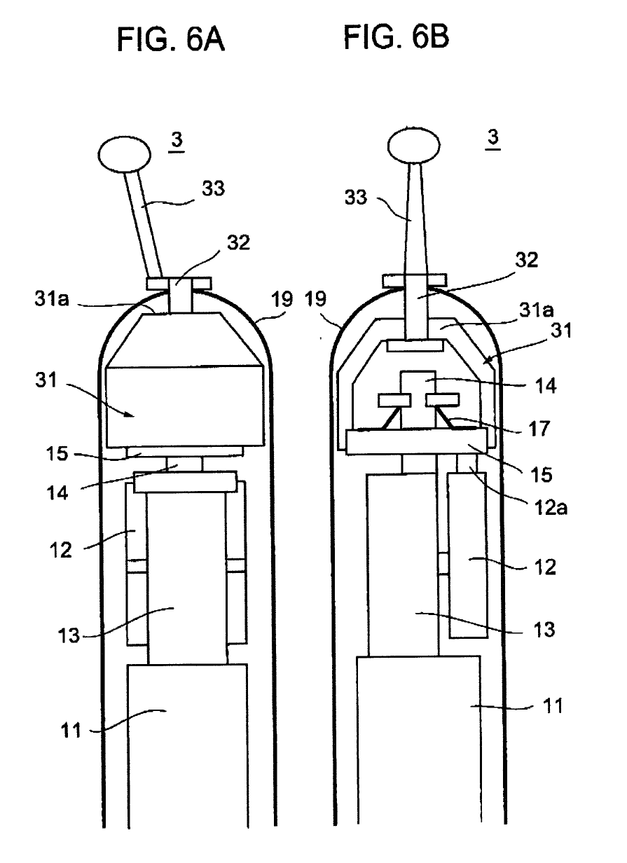

As shown by FIGS. 6A and 6B, a medical module apparatus 3 which is a third embodiment of the invention, is constructed by a constitution in which the distal end face of the guide wire 11 is integrated with the piezoelectric vibrator 12, the support member 13, the shaft 14, the rotating body 15 and the press spring 17 by a constitution similar to that of the medical module apparatus 1, the frame body 31 is fixed to the rotating body 15 such that a front end portion 31a thereof is disposed on the front side of the front end of the shaft 14 and does not interfere with the shaft 14 and the press spring 17, a shaft 32 is fixed to the front end portion 31a, a guiding member 33 is fixed to a front end of the shaft 32 to be inclined to the shaft 32, the medical module apparatus 3 is covered with the skin 19 except the front end of the shaft 32 and the guiding member 33 and the position detecting mechanism 16 and the drive control circuit 18 are provided by constitutions similar to those of the medical module apparatus 1. Here, the guiding member 33 is a rod-like member having a spherical body at a front end thereof. Further, according to the embodiment, the rotating body 15 is constituted by a circular plate with an object of downsizing the rotating body 15.

That is, the medical module apparatus 3 is an apparatus advancing in a desired direction when the apparatus advances, for example, in the vessel, by directing the front end of the guiding member 33 in a direction of the vessel into which the apparatus is to advance at a branch point of the vessel. In that case, since the front end of the guiding member is constituted by the spherical body, the inner wall of the vessel is not wounded.

According to the medical module apparatus 3, the guiding member 33 is rotated by the drive force of the piezoelectric vibrator 12 transmitted via the rotating body 15, the frame body 31 and the shaft 32. The rotatable range is 360 degree and therefore, the guiding member 33 can be directed in an arbitrary direction. Therefore, the guiding member 33 can advance in the arbitrary direction.

Further, a structure of integrating the piezoelectric vibrator 12, the support member 13 and the like is constructed by a constitution similar to that of the medical module apparatus 1 and accordingly, a sectional area of a space necessary for installing the members is to a degree substantially equal to the sectional area of the guide wire 11.

Therefore, the sectional area of the medical module apparatus 3 in the inserting direction becomes smaller than that of the conventional product and the medical module apparatus 3 can be inserted up to a deep portion in the body such as a deep portion of the vessel.

Fourth Embodiment

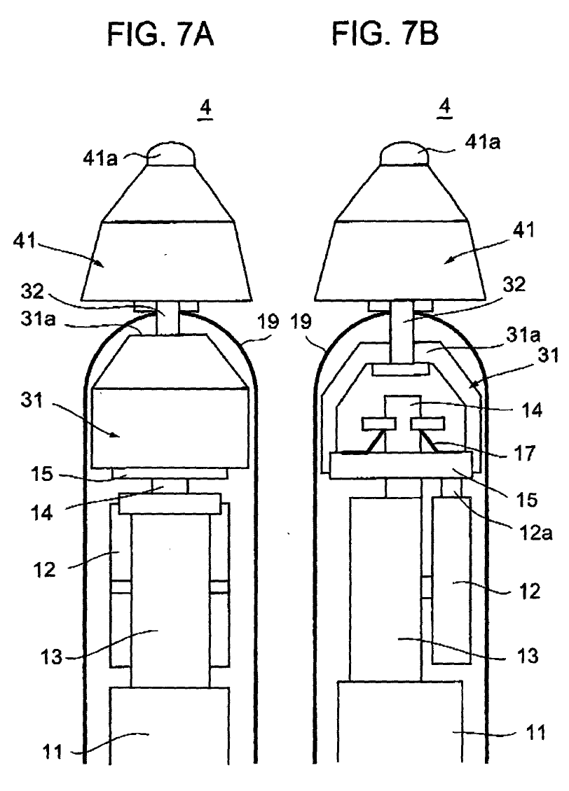

As shown by FIGS. 7A and 7B, a medical module apparatus 4 which is a fourth embodiment of the invention is constructed by a constitution substantially similar to that of the medical module apparatus 3, the medical module apparatus 4 is constructed by a structure in which in place of the guiding member 33, a removing member 41 is concentrically fixed to the front end of the shaft 32 and is an apparatus for expanding or opening a closed portion of the vessel or the like.

The removing member 41 is constructed by a constitution in which a front end face 41a is spherical and the sectional diameter is widened therefrom toward a back side thereof. In details, there is constructed a constitution in which the sectional diameter stays to be constant from the front end face 41a by about ⅕ of the removing member 41 and thereafter, the sectional diameter is widened toward the back side by about ⅖ thereof and the sectional diameter is widened slightly toward the back side by remaining ⅖ thereof.

That is, according to the medical module apparatus 4, the removing member 41 is rotated with the piezoelectric vibrator 12 as the power source and without limitation of the rotational amount. Therefore, by rotating the removing member 41 to push into and penetrate the thrombus or the like constituting the closed portion, the thrombus or the like can be cut to open and removed.

Further, since the sectional diameter of the removing member 41 is initially made constant and thereafter widened, the thrombus can be removed without effecting serious damage to the vessel.

Further, the medical module apparatus 4 can be inserted to the more slender vessel since the sectional area in the inserting direction can be made smaller than that of the conventional product similar to the medical module apparatus 3.

Further, the invention is not limited to the above-described respective embodiments but can pertinently be changed within the range not deviated from the gist of the invention.

According to the invention, there is constructed the constitution in which the output member is provided at the end portion of the piezoelectric oscillator substantially in a rectangular shape and the moving member is moved by power transmitted from the output member and therefore, the moving member such as the ultrasonic vibrator can be moved with excellent characteristics of the response without using a wire having high rigidity, further, the sectional area in the inserting direction can be reduced by downsizing the constitution. Therefore, the medical module apparatus can be inserted up to a deep portion in the body such as a deep portion of the vessel.

What is claimed is:

1. A medical module apparatus which is inserted into the body, the medical module apparatus comprising:
a piezoelectric vibrator substantially in a rectangular shape for producing ultrasonic vibration;
a moving member moved with the ultrasonic vibration produced at an end portion of the piezoelectric vibrator as a power;
a guide wire for supporting the piezoelectric vibrator and the moving member in a state in which the end portion of the piezoelectric vibrator is directed in a direction of inserting the medical module apparatus and moving the medical module apparatus to an aimed portion;
a skin for protecting the piezoelectric vibrator and the moving member against an outside portion; and
a drive circuit and a control circuit for controlling to drive the piezoelectric vibrator.

2. The medical module apparatus according to claim 1:
wherein a width of the piezoelectric vibrator in the direction of inserting the medical module apparatus is larger than 0 mm and equal to or smaller than 2 mm.

3. The medical module apparatus according to claim 1:
wherein the piezoelectric vibrator includes a first piezoelectric layer for producing vertical vibration and a second piezoelectric layer for producing bending vibration and the ultrasonic vibration of the end portion is elliptic vibration provided by synthesizing the vibrations produced in the first and the second piezoelectric layers.

4. The medical module apparatus according to claim 1:
wherein the moving member includes an inspection and treatment member.

5. The medical module apparatus according to claim 4:
wherein the inspection and treating member is an ultrasonic vibrator of an ultrasonic endoscope.

6. The medical module apparatus according to claim 4:
wherein the inspection and treatment member is a removing member inserted into the vessel for resolving a closed situation by removing a closed object at a closed portion of the vessel.

7. The medical module apparatus according to claim 1:
wherein the moving member is a guiding member projected from a distal end portion of the medical module apparatus with an angle therebetween for guiding the medical module apparatus in a desired direction by preceding the front end portion.

8. The medical module apparatus according to claim 1:
wherein the moving member is rotated by the piezoelectric vibrator.

9. The medical module apparatus according to claim 8:
wherein the moving member is penetrated rotatably by a shaft provided in the direction of inserting the medical module apparatus and the end portion of the piezoelectric vibrator is brought into contact with the moving member such that drive force of the piezoelectric vibrator is directed in a rotational direction of the moving body.

10. The medical module apparatus according to claim 1:
wherein the moving member is pivotally moved by the piezoelectric body.

11. The medical module apparatus according to claim 10:
wherein the moving member is pivotably penetrated by a shaft provided in a direction of a section of the medical module apparatus and the end portion of the piezoelectric vibrator is brought into contact with the moving member such that drive force is directed in a pivotally moving direction of the moving body.

12. The medical module apparatus according to claim 1:
wherein the drive circuit is a self-excited oscillation circuit.
